(19) United States
(12) Patent Application Publication
(10) Pub. No.: US 2024/0244358 A1
(43) Pub. Date: Jul. 18, 2024

(54) Speaker Box

(71) Applicant: AAC Microtech (Changzhou) Co., Ltd., Changzhou (CN)

(72) Inventors: Jinming Li, Changzhou (CN); Zhaoyu Yin, Changzhou (CN)

(21) Appl. No.: 18/314,162

(22) Filed: May 9, 2023

Related U.S. Application Data
(63) Continuation of application No. PCT/CN2023/085245, filed on Mar. 30, 2023.

(30) Foreign Application Priority Data
Jan. 17, 2023 (CN) 202320142109.3

(51) Int. Cl. H04R 1/02

(52) U.S. Cl. CPC H04R 1/025; H04R 1/021; H04R 2201/029

(57) ABSTRACT

The present disclosure discloses a speaker box including a shell and a speaker unit accommodated in the shell. The shell is provided with an acoustic channel for emitting sounds generated by the speaker unit from a side of the speaker box. A supporting wall for supporting and fixing the speaker unit is formed in the shell. The supporting wall is provided with a gap at the acoustic channel. A reinforcing rib is formed in the acoustic channel. A supporting rib extends from an end of the reinforcing rib close to the speaker unit into the gap. The speaker unit is supported and fixed on the supporting wall and the supporting rib. The speaker unit of the speaker box disclosed in the present disclosure can be supported reliably.

### FIELD OF THE PRESENT DISCLOSURE

The present disclosure relates to electroacoustic transducers, in particular to a speaker box.

### DESCRIPTION OF THE RELATED ART

A speaker box in the related art includes a shell and a speaker unit accommodated in the shell. The shell is provided with an acoustic channel for emitting sounds generated by the speaker unit from a side of the speaker box. A supporting wall for supporting and fixing the speaker unit is formed in the shell. The supporting wall is provided with a gap at the acoustic channel. The speaker unit is supported and fixed on the supporting wall.

Since the supporting wall is provided with a gap at the acoustic channel, the speaker unit lacks a reliable support at the gap, resulting in the speaker unit sinking at the gap and blocking part of the acoustic channel, thereby affecting acoustic performances of the speaker box.

Thus, it is necessary to provide a novel speaker box to solve the problem.

### SUMMARY

An objective of the present disclosure is to overcome the above technical problem and provide a speaker box of which a speaker unit can be supported reliably.

In order to achieve the objective mentioned above, the present disclosure discloses a speaker box including a shell and a speaker unit accommodated in the shell. The shell is provided with an acoustic channel for emitting sounds generated by the speaker unit from a side of the speaker box. A supporting wall for supporting and fixing the speaker unit is formed in the shell. The supporting wall is provided with a gap at the acoustic channel. A reinforcing rib is formed in the acoustic channel. A supporting rib extends from an end of the reinforcing rib close to the speaker unit into the gap. The speaker unit is supported and fixed on the supporting wall and the supporting rib.

As an improvement, the shell includes an upper shell and a lower shell engaged with the upper shell. The upper shell includes a bottom wall and the supporting wall protruding from the bottom wall. The acoustic channel is formed in the upper shell. The speaker unit is spaced apart from the bottom wall for forming a front cavity communicated with the acoustic channel.

As an improvement, the upper shell includes an upper shell plastic main body part and an upper shell steel sheet combined with the upper shell plastic main body part by injection molding. The lower shell includes a lower shell plastic main body part and a lower shell steel sheet combined with the lower shell plastic main body part by injection molding.

As an improvement, the upper shell plastic main body part and the lower shell plastic main body part are combined by ultrasonic welding.

As an improvement, the reinforcing rib locates in the middle of the acoustic channel.

As an improvement, the speaker box further includes a printed circuit board electrically connecting the speaker unit with an external circuit. The printed circuit board includes a first part located inside the shell and a second part located outside the shell. The first part is fixed to the speaker unit. The first part is provided with a first positioning hole. The upper shell is provided with a first positioning pillar located in the first positioning hole. The second part is fixed to the lower shell. The second part is provided with a second positioning hole. The lower shell is provided with a second positioning pillar located in the second positioning hole.

In the speaker box according to the present disclosure, the supporting rib extends from the reinforcing rib formed in the acoustic channel into the gap. The speaker unit is supported and fixed on the supporting wall and the supporting rib, so that the speaker unit can be supported reliably. Thus, the technical problem of the speaker unit lacking a reliable support at the gap, resulting in the speaker unit sinking at the gap and blocking part of the acoustic channel, thereby affecting acoustic performances of the speaker box can be solved.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is an isometric view of a speaker box in accordance with an exemplary embodiment of the present disclosure.

FIG. 2 is an exploded view of the speaker box in FIG. 1.

FIG. 3 is an isometric view of an upper shell of the speaker box in FIG. 1.

FIG. 4 is an isometric view of the speaker box in FIG. 1, removing an upper shell.

FIG. 5 is an isometric view of the speaker box in FIG. 1, removing a lower shell.

FIG. 6 is a cross-sectional view of the speaker box, taken along line A-A in FIG. 1.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

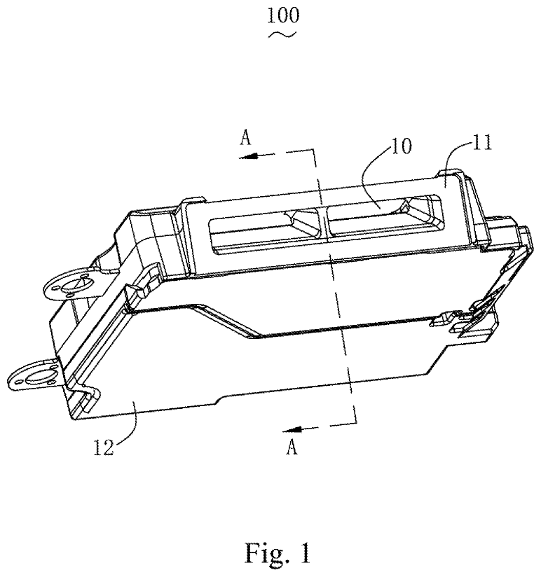

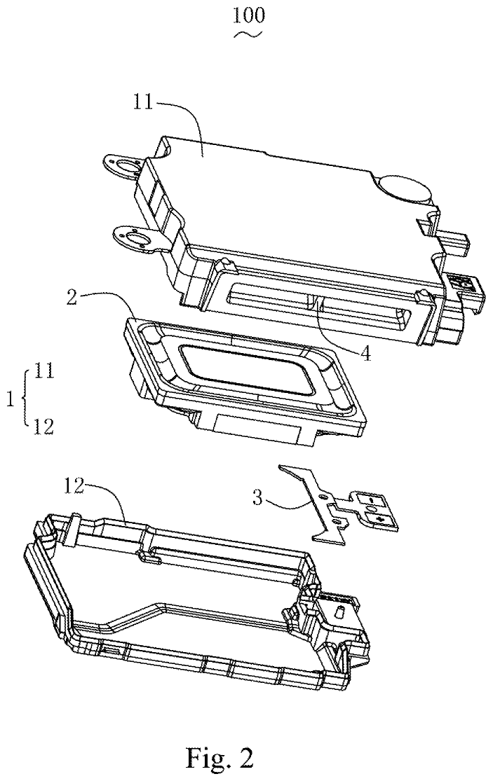

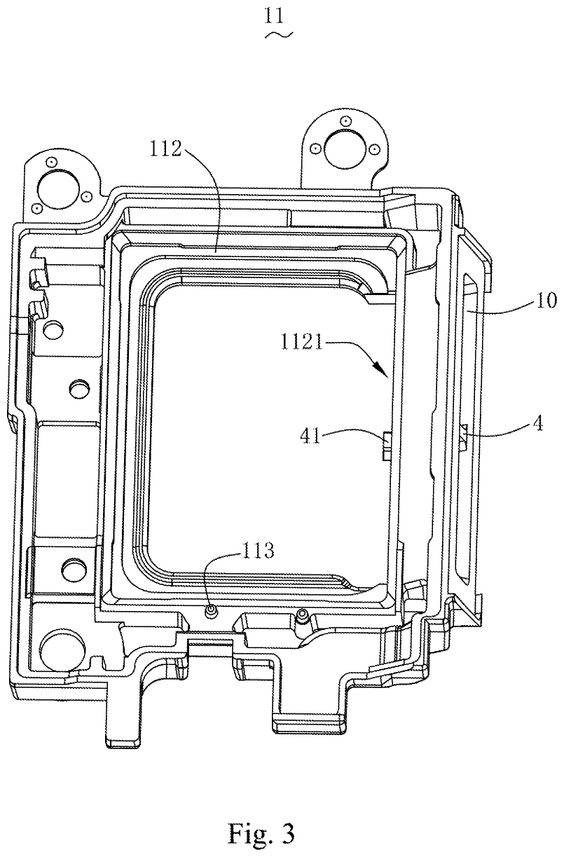

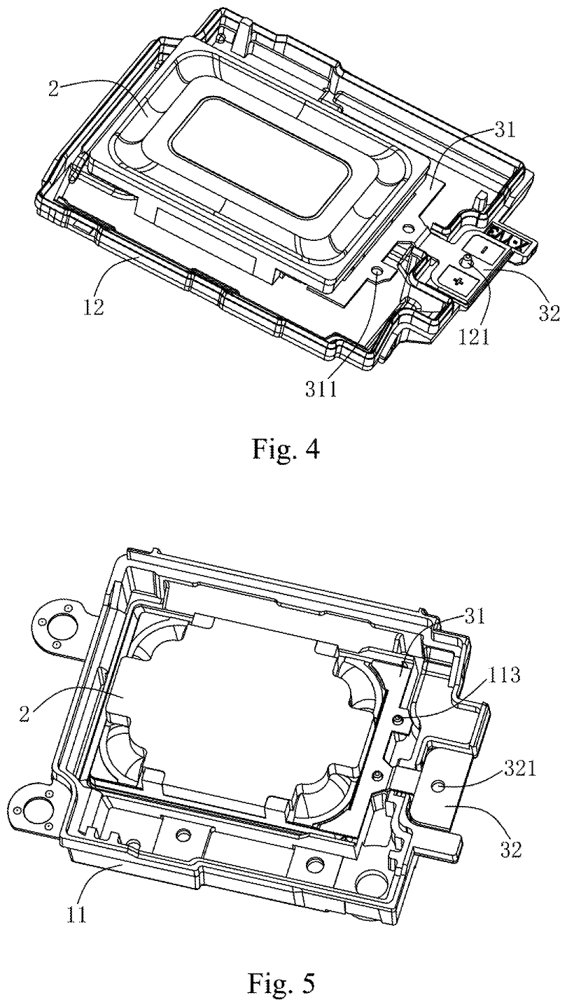

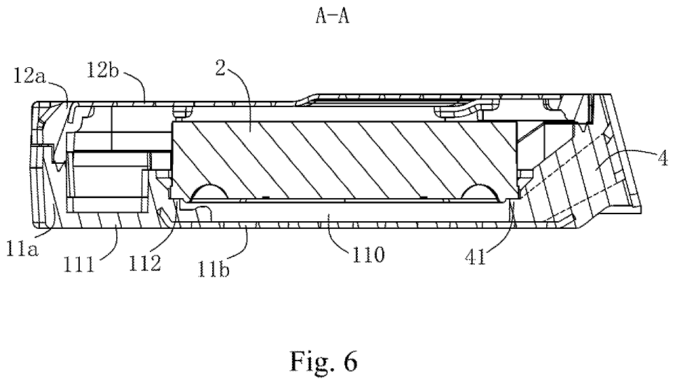

Referring to FIGS. 1-6, the present disclosure discloses a speaker box 100 including a shell 1 and a speaker unit 2 accommodated in the shell 1.

The shell 1 is provided with an acoustic channel 10 for emitting sounds generated by the speaker unit 2 from a side of the speaker box 100. A supporting wall 112 for supporting and fixing the speaker unit 2 is formed in the shell 1. The supporting wall 112 is provided with a gap 1121 at the acoustic channel 10. A reinforcing rib 4 is formed in the acoustic channel 10. A supporting rib 41 extends from an end of the reinforcing rib 4 close to the speaker unit 2 into the gap 1121. The speaker unit 2 is supported and fixed on the supporting wall 112 and the supporting rib 41. Optionally, the reinforcing rib 4 locates in the middle of the acoustic channel 10.

Optionally, the shell 1 includes an upper shell 11 and a lower shell 12 engaged with the upper shell 11.

The upper shell 11 includes a bottom wall 111 and the supporting wall 112 protruding from the bottom wall 111. The acoustic channel 10 is formed in the upper shell 11. The speaker unit 2 is spaced apart from the bottom wall 111 for forming a front cavity 110 communicated with the acoustic channel 10.

The speaker box 100 further includes a printed circuit board 3 electrically connecting the speaker unit 2 with an external circuit. The printed circuit board 3 includes a first part 31 located inside the shell 1 and a second part 32 located outside the shell 1. The first part 31 is fixed to the speaker unit 2. The first part 31 is provided with a first positioning hole 311. The upper shell 11 is provided with a first positioning pillar 113 located in the first positioning hole 311. The second part 32 is fixed to the lower shell 12. The second part 32 is provided with a second positioning hole 321. The lower shell 12 is provided with a second positioning pillar 121 located in the second positioning hole 321.

Optionally, the upper shell 11 includes an upper shell plastic main body part 11a and an upper shell steel sheet 11b combined with the upper shell plastic main body part 11a by injection molding. The lower shell 12 includes a lower shell plastic main body part 12a and a lower shell steel sheet 12b combined with the lower shell plastic main body part 12a by injection molding. The upper shell plastic main body part 11a and the lower shell plastic main body part 12a are combined by ultrasonic welding.

In the speaker box 100 according to the present disclosure, the supporting rib 41 extends from the reinforcing rib 4 formed in the acoustic channel 10 into the gap 1121. The speaker unit 2 is supported and fixed on the supporting wall 112 and the supporting rib 41, so that the speaker unit 2 can be supported reliably. Thus, the technical problem of the speaker unit lacking a reliable support at the gap, resulting in the speaker unit sinking at the gap and blocking part of the acoustic channel, thereby affecting acoustic performances of the speaker box can be solved.

The above are only embodiments of the present disclosure. It should be pointed out that those of ordinary skill in the art may also make improvements without departing from the ideas of the present disclosure, all of which fall within the protection scope of the present disclosure.

What is claimed is:

1. A speaker box, comprising a shell and a speaker unit accommodated in the shell, wherein the shell is provided with an acoustic channel for emitting sounds generated by the speaker unit from a side of the speaker box, a supporting wall for supporting and fixing the speaker unit is formed in the shell, the supporting wall is provided with a gap at the acoustic channel, a reinforcing rib is formed in the acoustic channel, a supporting rib extends from an end of the reinforcing rib close to the speaker unit into the gap, the speaker unit is supported and fixed on the supporting wall and the supporting rib.

2. The speaker box as described in claim 1, wherein the shell comprises an upper shell and a lower shell engaged with the upper shell, the upper shell comprises a bottom wall and the supporting wall protruding from the bottom wall, the acoustic channel is formed in the upper shell, the speaker unit is spaced apart from the bottom wall for forming a front cavity communicated with the acoustic channel.

3. The speaker box as described in claim 2, wherein the upper shell comprises an upper shell plastic main body part and an upper shell steel sheet combined with the upper shell plastic main body part by injection molding, the lower shell comprises a lower shell plastic main body part and a lower shell steel sheet combined with the lower shell plastic main body part by injection molding.

4. The speaker box as described in claim 3, wherein the upper shell plastic main body part and the lower shell plastic main body part are combined by ultrasonic welding.

5. The speaker box as described in claim 1, wherein the reinforcing rib locates in the middle of the acoustic channel.

6. The speaker box as described in claim 2, further comprising a printed circuit board electrically connecting the speaker unit with an external circuit, wherein the printed circuit board comprises a first part located inside the shell and a second part located outside the shell, the first part is fixed to the speaker unit, the first part is provided with a first positioning hole, the upper shell is provided with a first positioning pillar located in the first positioning hole, the second part is fixed to the lower shell, the second part is provided with a second positioning hole, the lower shell is provided with a second positioning pillar located in the second positioning hole.
